(19) United States
(12) Patent Application Publication
(10) Pub. No.: US 2026/0229083 A1
(43) Pub. Date: Aug. 6, 2026

(54) MODULAR STORAGE COMPARTMENTS WITH CONFIGURABLE LIDS

(71) Applicant: W.W. GRAINGER, INC, Lake Forest, IL (US)

(72) Inventors: Beth PSTRAK, Libertyville, IL (US); Bennord LEE, Houston, TX (US)

(21) Appl. No.: 19/530,062

(22) Filed: Feb. 4, 2026

Related U.S. Application Data
(60) Provisional application No. 63/753,513, filed on Feb. 4, 2025.

(51) Int. Cl. G07F 11/60; G07F 9/00; G07F 11/72

(52) U.S. Cl. CPC G07F 11/60; G07F 9/006; G07F 9/009; G07F 11/72

(57) ABSTRACT

A coupling system for vending machine compartment lids to accommodate variable physical open-top compartment configurations on a drawer. Multiple compartment lids can be configured on the drawer to accommodate various open-top compartment configurations. The compartment lids can accommodate a wide variety of different sized products without having to be removed or replaced. The coupling system can be used to connect or link one or more compartment lids together to cover various sized open-top compartments on the drawer. The connected or linked lids can be moved between an open position allowing access to respective receptacles of the open-top compartments and a closed position restricting access to the receptacles of the open-top compartments. The coupling system and compartments in some embodiments are electromechanically actuated using sensors, controllers, and other control hardware. The advantageous feature allows for larger products to be stored on the drawer and secured therein with compartment lids without having to replace the existing drawers or lids.

### CROSS-REFERENCE TO RELATED APPLICATIONS

This application claims priority to and benefit of U.S. Provisional Application No. 63/753,513, filed Feb. 4, 2025, the disclosure of which is incorporated by reference herein in its entirety.

### TECHNICAL FIELD

The present disclosure relates generally to vending systems and more particularly to modular vending machine drawers with reconfigurable lids, weight-based inventory tracking systems, and automated control features for enhanced security and inventory management.

### BACKGROUND

An automated inventory vending machine generally is a controlled inventory storage device or cabinet that allows inventory to be securely stored and dispensed near a point-of-sale and/or point-of-use. Typical vending machines provide for a plurality of receptacles (e.g., rows, trays, or columns) for holding units of products, and a dispensing mechanism operable to dispense a product from each receptacle.

A vending machine typically holds a finite number of units of a variety of different products and is refilled by an operator (e.g., a route driver) on a periodic or non-periodic basis. The configuration, optimization, and/or inventory of vending machines vary based on a catalog of products. Typically, vending machines include drawers with fixed size bins and lids that are not reconfigurable. Therefore, to secure additional products or switch products of a different size in an individual bin of the drawer, the physical drawer or the entire drawer lid would need to be replaced to secure the product location.

Additionally, conventional vending machines lack real-time inventory tracking capabilities, requiring manual inventory counts or relying on user input to determine remaining product quantities. This creates inefficiencies in restocking operations and can lead to stockouts or overstocking. Furthermore, traditional vending machines may suffer from lid jamming when drawers are not fully extended, tampering concerns, and limited user feedback mechanisms such as lighting or visual confirmation systems.

Therefore, it would be advantageous to have individual compartment lids that can be reconfigurable with open-top compartments of a vending machine drawer to provide security without the need to replace or remove compartment lids.

### SUMMARY

The present disclosure relates to a coupling system for vending machine compartment lids among other benefits. It is desirable to provide a drawer with variable physical configurations to accommodate a wide variety of products. Dividers can be arranged on the drawer to define a plurality of open-top compartments with corresponding receptacles. The dividers can be added or removed from the drawer to rearrange the volume on the drawer as desired based on products to be stored therein.

Multiple compartment lids can be configured on the drawer to accommodate a variety of open-top compartment configurations. That is, one or more compartment lids can be coupled together to move between an open position allowing access to respective receptacles of the open-top compartments and a closed position restricting access to the receptacles of the open-top compartments. The advantageous feature allows a user to reconfigure existing compartment lids on the drawer to cover and secure a larger receptacle of reconfigured open-top compartments modified to store larger products without having to replace the existing drawers or compartment lids. For example, to store larger products on a drawer of a vending cabinet, a user may reconfigure the open-top compartments by removing dividers to open up the spacing to provide a larger receptacle. The coupling system according to the present disclosure can be used to link or connect one or more compartment lids together such that the linked or connected compartment lids together cover the larger receptacle and products stored therein. As such, a user is not required to remove or exchange drawers or compartment lids to accommodate larger products needing to be secured in the drawer. In certain aspects, the vending machine can incorporate weight-based inventory tracking technology. Scale components including load cells can be integrated into one or more drawers to measure weight displacement and calculate remaining inventory based on calibrated product weights. The scale technology allows for real-time or periodic inventory counts without manual counting, improving visibility of stock levels and enabling automated alerts when inventory reaches predetermined minimum levels.

The vending machine in some embodiments, further comprises enhanced control features to improve operational reliability and user experience. These features further comprise drawer position sensors to prevent compartment lid actuation when drawers are not fully extended, thereby reducing lid jamming and damage. Lighting systems can be integrated throughout the drawers and compartments to signal vending selections, replenishment needs, or hardware issues. The device can also support networked configurations allowing multiple vending machines to be daisy-chained together to create customized vending solutions.

Aspects of the present disclosure relate to a vending machine that includes an enclosure that defines an interior volume. The vending machine may include a plurality of drawers that are slidably movable with respect to the interior volume of the enclosure. The plurality of drawers can each include one or more open-top compartments defined therein by at least one divider. One or more of the plurality of drawers further comprises an integrated scale components comprising a platform, at least one load cell, and a junction hub configured to measure weight displacement within the one or more open-top compartments. The plurality of drawers may be slidably movable between a closed position in which the one or more open-top compartments are enclosed within the interior volume and an open position in which the one or more open-top compartments are at least partially accessible. The vending machine also includes a plurality of lids each hingedly attached to the drawer to respectively cover the one or more open-top compartments of an associated one of the plurality of drawers. Each lid may include a curved lip along an outer edge to reduce tampering and potential damage. Each lid can be configured to open to provide access to the corresponding one or more open-top compartments when the corresponding drawer is in the open position. One or more connectors can be used to couple together one or more of the plurality of lids with an adjacent lid. Where, when at least one divider is removed from the drawer to reconfigure the one or more open-top compartments to a larger volume on the drawer, the one or more coupled lids cover the larger volume provided on the drawer.

Another aspect of the present disclosure relates to a method for assembling a modular vending drawer. The method includes mounting a plurality of panels within the drawer, the panels can be configured to fit between first and second ends of the drawer. Mounting a plurality of dividers between each frame, the dividers can be configured to fit within slots defined in the panels connecting together the plurality of dividers to define a plurality of open-top compartments. The open-top compartment can be reconfigurable to define larger spaces on the drawer. Mounting a plurality of lids over a respective one of the plurality of open-top compartments and connecting one or more of the plurality of lids together to cover larger spaces on the drawer when one or more open-top compartments are reconfigured.

A further aspect of the present disclosure relates to a retrofit kit for a vending drawer usable with a vending cabinet. The retrofit kit may include a plurality of dividers attachable to the vending drawer to redefine open-top compartments. The retrofit kit also may include a coupling system to link together existing compartment lids associated with a respective one of the redefined open-top compartments. The linked compartment lids can be movable between an open position to provide access to the respective open-top compartments and a closed position to restrict access to the respective open-top compartments.

Another aspect of the present disclosure relates to a vending machine with integrated weight-based inventory tracking. The vending machine includes a drawer having at least one open-top compartment, a scale system integrated with the drawer comprising a platform, at least one load cell configured to detect force applied to the platform, and a junction hub configured to convert detected force to weight measurements. The vending machine also includes a controller operably connected to the scale system, the controller configured to: calibrate the scale system to a predetermined product weight, calculate remaining inventory based on weight measurements from the scale system, and generate alerts when remaining inventory reaches a predetermined threshold. The controller further comprising in some aspects of the present disclosure integration into a networked vending system.

A further aspect of the present disclosure relates to a networked vending system comprising a plurality of vending machines connected via network cables, wherein each vending machine can be configured with varying levels of security to create a customized micro-mart of vending solutions.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates a perspective view of an example cabinet assembling including multiple drawers and compartment lids in accordance with principles of the present disclosure.

FIG. 1A illustrates an enlarged view of a portion of FIG. 1.

FIG. 2 illustrates a top of one of an example drawer with multiple dividers defining open-top compartments in accordance with the principles of the present disclosure.

FIG. 3 illustrates a perspective exploded view of a portion of FIG. 2.

FIG. 4 illustrates a perspective view of another example cabinet assembly including multiple drawers and compartment lids in accordance with the principles of the present disclosure.

FIG. 4A illustrates an enlarged view of a portion of FIG. 4.

FIG. 5 illustrates a top cross-sectional view of a bottom of an example drawer depicting channels, wiring harnesses and solenoids in accordance with the principles of the present disclosure.

FIG. 6 illustrates a top view of an example drawer depicting dividers and partitions in accordance with the principles of the present disclosure.

FIGS. 7-9 illustrate an example drawer single sided hinge divider in accordance with the principles of the present disclosure.

FIGS. 10-12 illustrate an example drawer double sided hinge divider in accordance with the principles of the present disclosure.

FIG. 13 is a cross-sectional side view of the drawer of FIG. 5 depicting the compartment lids in open positions.

FIG. 14 illustrates a top view of several compartment lids coupled together using a coupling system in accordance with the principles of the present disclosure.

FIG. 15 illustrates a top view of one compartment lid.

FIGS. 16-18 illustrate an example single sided lock divider in accordance with the principles of the present disclosure.

FIG. 19 illustrates a top view of the example drawer of FIG. 1.

FIG. 20 illustrates a cross-sectional top view of the drawer of FIG. 1.

### DETAILED DESCRIPTION

The present disclosure relates to electronically enabled cabinet assemblies and enclosures for a vending machine. The cabinet assemblies include drawers with added security through the installation of individual lids that can be reconfigurable with respect to individual compartments (e.g., bins, containers) of the drawer. The individual compartments can be modular such that multiple size products can be arranged therein. That is, the drawers may be reconfigured to receive any number of products and/or different size products. Additionally various sensors, lights, electromechanical specifications connected and networked with a plurality of vending machines are part of various embodiments of this solution.

The drawer compartments may be reconfigured with dividers to reduce the space for a specific product or to enlarge the space for one or more products by removing dividers. By having a modular design, the drawer spacing can be reconfigurable without replacing the drawers or lids. Respective lids may be reconfigured to accommodate an enlarged or reduced spacing on the drawer without having to replace the drawers or lids. Accordingly, the advantageous feature of the assembly allows for flexibility to reconfigure individual compartments and lids that cover them for each drawer in the cabinet assembly. This reconfiguration can create a larger product space while keeping all adjacent product locations the same. If the product location needs to be reconfigured again, the user can add back in the drawer dividers and uncouple the lids to change the production location to the original or reduced size. The drawer itself will be an industry standard vending drawer. Typically, standard vending drawers are approximately 27 inches in length, 29.5 inches in width, and 50.5 inches in height, although alternative sizes are possible. In other examples, larger vending drawers may be approximately 29.5 inches in length, 48 inches in width, and 50.5 inches in height, although alternatives are possible. The present disclosure is focused on the lid design with the ability to reconfigure, which differs from other industry designs.

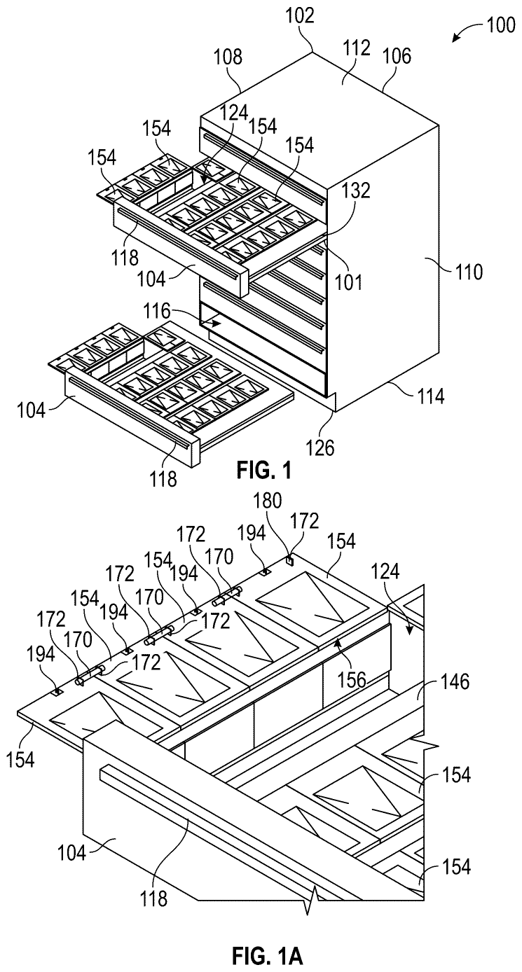

FIG. 1 is a perspective view of one example cabinet assembly 100 (i.e., vending machine) in accordance with the present disclosure. The cabinet assembly 100 includes an enclosure 102 that defines an interior volume 101 (i.e., cavity) for holding one or more sliding drawers 104 (i.e., vending drawer) that slides between an open position and a closed position. The sliding drawer 104 includes a drawer label location and a handle 118 for moving the drawer between the open and closed positions. The enclosure 102 may have physical dimensions of approximately 26 inches by 29.5 inches by 46 inches, although larger alternatives are possible. As depicted, the example enclosure 102 has the capacity to hold eight drawers, each of which can have the same height. It should be understood that a vertical stack of eight drawer slots in the enclosure 102 is exemplary and that other configurations are possible. In other examples, any number of drawers can be configured within the limits of the cabinet assembly 100. As such, in certain examples, the capacity of the cabinet assembly 100 may change based on the number of drawers 104. In other examples, the drawers 104 may have varying heights.

The example enclosure 102 has a rear panel 106, a first side panel 108, a second side panel 110 opposite the first side panel 108, a top panel 112, and a bottom panel 114 opposite the top panel 112 that together define an internal cavity 116. The sliding drawers 104 can be held within the internal cavity 116 of the enclosure 102. These panels are connected together, for example, by rivets, bolts, welding or other conventional techniques or combinations thereof. In certain examples, the panels can be constructed from sheet metal, although alternatives are possible. In other examples, the panels can be constructed from plastic composite structures or molded structures, although alternatives are possible. In still other examples, the panels can be constructed from a combination of metal and plastics.

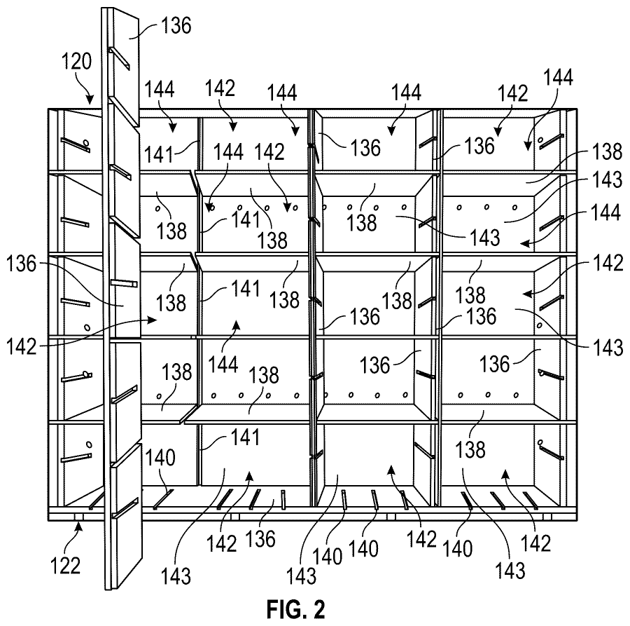

FIG. 2 is a representative top view of drawer 104. In certain examples, the drawer 104 is generally rectangular in shape and includes a front end 120, a back end 122, a top side 124 (see FIG. 1), a bottom side 126, and opposite first and second sides 128, 130. Each of the drawers 104 includes a sliding mechanism. The sliding mechanism may include rail supports 132 respectively positioned on the first and second sides 128, 130 of the drawer 104 and telescopic rails (not shown) positioned on an interior side of the enclosure 102 that cooperate with the rail supports 132. The sliding mechanisms for each drawer 104 are evenly spaced within the enclosure 102. As such, each drawer 104 will be able to fit into the enclosure 102 in a uniform manner and can be equally spaced from one another and slide in and out of the enclosure 102.

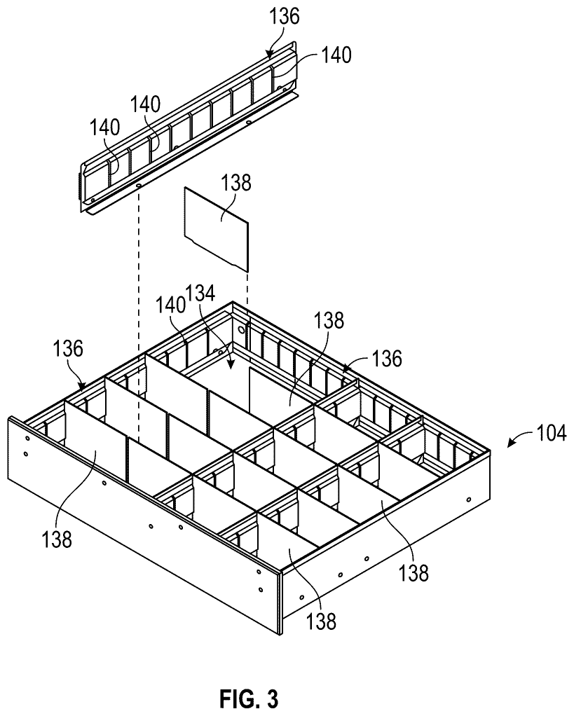

Turning to FIG. 3, an exploded view of the drawer 104 of FIG. 2 is depicted. The drawer 104 can have one or more interior sections 134. In some examples, the interior sections 134 may not have any internal partitions which may provide a larger volume or receptacle. In the example depicted, the interior sections 134 of the drawer 104 include five removable interior walls 136 (e.g., partitions, barriers, dividers) that can span vertically between and can be connected to the front and back ends 120, 122 via channels or slots 140, although alternatives are possible. The removable interior wall 136 may also be used as perimeter walls within the drawer 104.

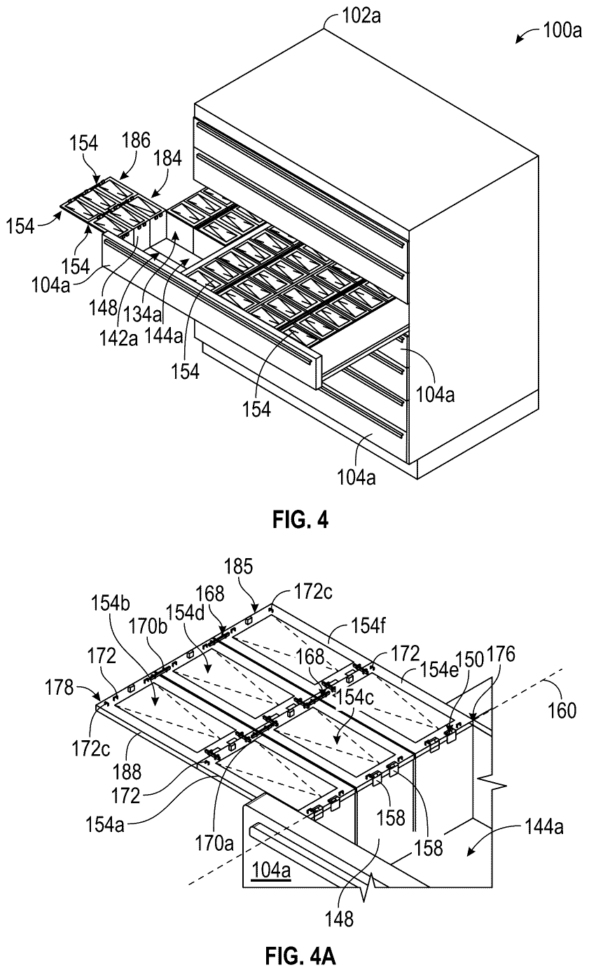

FIG. 4 depicts another example cabinet assembly 100a with an enclosure 102a in which a plurality of drawers 104a are housed. In the example illustrated, seven drawers 104a are included in the cabinet assembly 100a. It will be appreciated that other drawer configurations may be employed without departing from the scope of the disclosure. The drawer 104a is shown with an increased capacity compared to drawer 104 of cabinet assembly 100 thus widening the total size of the enclosure 102a.

Referring now to the weight-based inventory tracking features, one or more of the drawers 104, 104a can be equipped with integrated scale technology to provide real-time or periodic inventory monitoring. The scale system enables automated inventory tracking based on weight displacement, eliminating the need for manual counting and providing enhanced visibility of remaining stock levels.

The scale system can include several key hardware components integrated into the drawer structure. A platform or plate can serve as the weighing surface for products stored in the compartments 142, 142a. The thickness of the platform can affect the accuracy of weight measurements, and in certain examples, the platform may be constructed from steel or aluminum with a thickness selected to provide both structural rigidity and measurement sensitivity.

At least one load cell can be mounted to the drawer 104, 104a to detect force applied to the platform. In certain embodiments, single point beam load cells may be used. In other embodiments, platform load cells may be employed. The load cells can be selected based on the expected weight range of products to be stored. For example, load cells with maximum capacity of 25 pounds or 50 pounds per location or single point on the platform provide adequate coverage for typical vending applications, although alternatives are possible. The minimum weight detection capability of the load cells can depend on software sensitivity settings and calibration parameters as well as the type of product to be vended.

A junction hub and analog-to-digital converter (ADC) can be operably connected to the load cell(s) to convert analog force measurements into digital weight values. The junction hub can aggregate signals from multiple load cells if present and communicate weight data to a controller or processor for inventory calculations.

Wiring management features can be integrated into the drawer design to protect electrical connections for the scale components. Additionally, vibration dampening pads may be positioned between the load cells and the drawer structure to reduce the impact of vibrations on measurement accuracy. Despite vibration dampening, some movement may still be detected during transactions, so the system can be configured to take weight readings at specific points in the transaction cycle when the drawer and platform are stationary.

Each scale location can be calibrated to a specific product SKU. During initial setup, a user can calibrate each scale by placing a known quantity of the product in the designated compartment and inputting the quantity into the system. The controller can then calculate the unit weight for that product. In certain embodiments, calibration can be performed with or without compartment bins in place, allowing flexibility based on the drawer configuration. Only one SKU may be assigned to each scale location in initial implementations to ensure measurement accuracy, although future versions may support multiple SKUs per location.

During operation, when a drawer 104, 104a is closed after a transaction, the controller can calculate the remaining weight in each scale-equipped compartment 142, 142a and determine the number of items remaining based on the calibrated unit weight. If a user removes an item and then replaces it in the drawer, the controller can detect the weight change and may notify the user of a potential error or issue.

The scale system can account for various environmental factors that may affect measurement accuracy. Temperature and humidity changes can cause the platform and load cell components to expand and contract, potentially impacting readings. The system can be configured with algorithms to compensate for environmental variations or can prompt periodic recalibration. Additionally, scales may experience drift over time due to environmental factors and daily wear, wherein scale readings slowly change. The system can track measurement uncertainty and error, and can send electronic reminders to users for periodic calibration on an annual or semi-annual basis.

Users may retrofit existing drawers 104, 104a with scale technology, installing scales throughout the entire device or only in desired locations based on inventory management needs. This modular approach allows for flexible implementation based on cost considerations and tracking requirements for different product types.

Referring back to FIG. 3, the removable interior walls 136 may be moved to any desired location within the interior section 134 of the drawer 104 to modify the spacing on the drawer 104. The removable interior walls 136 may be secured to the drawer 104, for example, by rivets, bolts, welding or other conventional techniques or combinations thereof, although alternatives are possible. In certain examples, the removable interior walls 136 may have a length between 6 inches and about 12 inches, although alternatives are possible. In certain examples, the removable interior walls 136 may have a width of about 4 inches, although alternatives are possible.

Still referring to FIG. 3, removable dividing walls 138 (e.g., partitions, barriers, dividers) may be positioned in any desired location within the interior sections 134 to further reconfigure the spacing on the drawers 104. The removable dividing walls 138 may respectively span horizontally between the removable interior walls 136. In one example, the removable dividing walls 138 can be designed to be interconnected with the removable interior walls 136 via the slots 140 defined in interior sides of the removable interior walls 136 and channels 141 (see FIG. 2) defined in a base 143 of the drawer 104 to form individual compartments 142 usable to store devices (e.g., products, components). Each of the compartments 142 provide a receptacle 144 (e.g., empty cell, hole, void, space, cavity) for receiving a device. The spacing and size of the compartments 142 may be uniform, as illustrated in FIGS. 2-3, although alternatives are possible. Each individual compartments 142 can be sized and configured as desired to allow one or more devices to be easily accommodated and changed to meet varying demands of users. For example, the number of compartments 142 may decrease as the size of the receptacles 144 of one or more of the compartments 142 change, see FIG. 4.

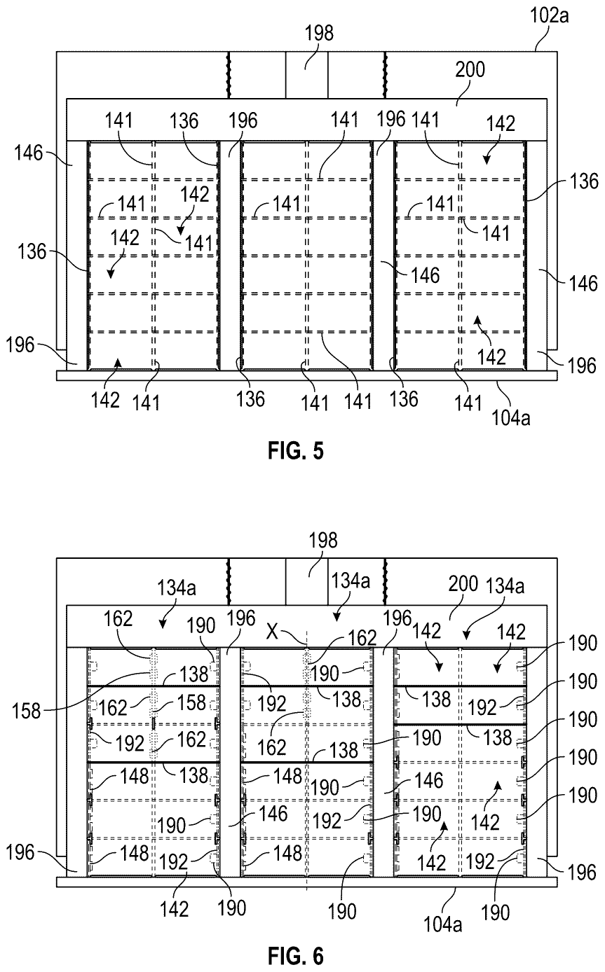

Turning to FIGS. 5-6, a top view of a first drawer 104a is shown partially withdrawn from the enclosure 102a. The drawer 104a is divided into individual compartments 142 here arranged as thirty-six individual compartments 142 with twelve individual compartments 142 being positioned in a given section 134a of the drawer 104a to provide a total of three sections 134a. The three sections 134a are separated in the drawer 104a by drawer tracks 146. The drawer tracks 146 can define cavities for storing wiring harnesses. It will be appreciated that various drawer configurations may be employed without departing from the scope of the disclosure.

Furthermore, the individual compartments 142 of the drawer 104a can vary in size. In one example, the individual compartments 142 may be between about 4 inches to about 6 inches in width, between about 3.0 to 3.5 inches in height and between about 3 inches to 4 inches in length. It will be appreciated that other compartment sizes are possible. The height of the drawer 104a may remain constant and not change with configurations.

The removable dividing walls 138 and/or the removable interior walls 136 can be respectively positioned horizontally and/or vertically on the drawers 104, 104a and can be reconfigured as desired. In certain examples, neighboring compartments 142 within sections 134, 134a of the drawers 104, 104a can be reconfigured by removing the removable dividing walls 138 and/or the removable interior walls 136 to create a larger compartment. The removable dividing walls 138 and/or the removable interior walls 136 can be added back in the drawers 104, 104a to return the compartments 142 back to their original size.

The cabinet assemblies 100, 100a may also be equipped with additional divider components to reconfigure the spacing on the drawer to change compartment sizes. If a larger compartment is desired, the divider components can be removed to create larger compartments. During later use, the dividers can be added back into the drawer to return compartments back to their original sizes. In certain examples, the spacing of each section 134a of the drawer 104a can be reconfigured up to about 12 inches in width and up to about 21 inches in length, although alternatives are possible.

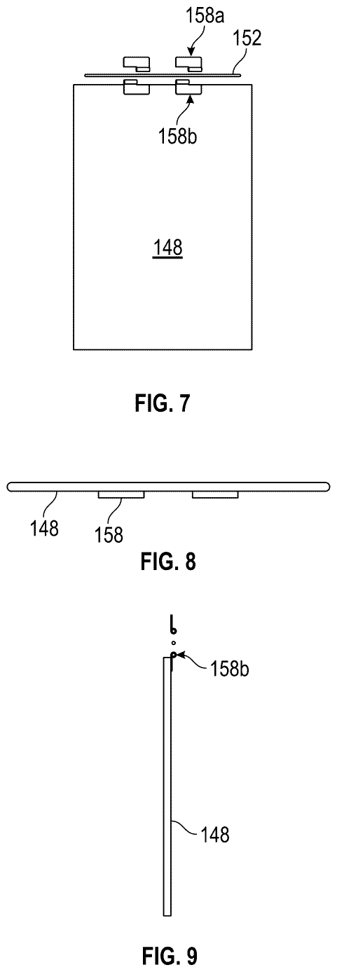

FIGS. 7-9 illustrate an example divider component 148 that may be hingedly attached 150 (see FIG. 4A) via hinge rod 152 to the drawers. The hinge rod 152 attaches in a manner that allows the divider component 148 to pivot about the hinge rod 152. The divider 148 can be added to any drawer 104, 104a of the cabinet assemblies 100, 100a to couple individual compartments 142, 142a together, which will be described below with reference to FIG. 6. In one example, a maximum of twelve individual compartments 142a may be joined together in respective sections 134a on the drawer 104a, although alternatives are possible.

Turning again to FIG. 6, the removable dividing walls 138 and the removable interior walls 136 can be removed from portions of the three sections 134a on the drawer 104a. As such, any number of compartments can be joined together in the sections 134a up to a maximum of twelve compartments 142a. For example, two compartments 142a, four compartments 142a, six compartments 142a, eight compartments 142a, ten compartments 142a and twelve compartments 142a can be joined together to form larger receptacles 144 per section 134a.

A plurality of compartment lids 154 (e.g., covers) may be included on the drawers 104, 104a to correspond with one or more of the respective compartments 142, 142a. As depicted in FIG. 1, the compartment lids 154 may be hingedly attached 156 to a top of the compartments 142, respectively, to be opened and closed when the drawer 104 is in the open position. The advantageous feature of the compartment lids 154 being reconfigurable to cover various receptacle sizes without having to replace the drawer or the compartment lids 154 as the dimensions of the receptacles change. Prior systems require replacement of lids or drawers when dimensions of a receptacle in the drawer changes. The present disclosure allows the compartment lids 154 to be configurable to both cover the original sized receptacles of the compartments 142, 142a and larger receptacles of any number of joined compartments 142, 142a without having to replace the entire lid or replace the physical drawer as changes to the dimensions of the product location are made.

The compartment lids 154 may be comprised of metal, plastic or a combination of both. The compartment lids 154 may preferably be clear or translucent, such that a user may identify components in the compartments 142, 142a. One or more of the compartment lids 154 may further comprise markings or labels. In other examples, the compartment lids 154 may include a window, enclosure, or slot to retain a label.

The compartment lids 154 may include enhanced design features to improve security, durability, and user experience. In certain embodiments, the compartment lids 154 can include a curved lip along an outer edge thereof. The curved lip can reduce the risk of tampering, security breaches, and potential damage when opening the compartments 142, 142a. The curved profile can make it more difficult to insert tools or fingers between the lid and drawer surface for unauthorized access.

As noted previously, the compartment lids 154 may be clear or translucent to provide visibility of products stored within the compartments 142, 142a. This visual confirmation feature can assist users who need to verify product selection before completing a transaction, and can be particularly beneficial for users who speak English as a second language or prefer visual confirmation over text descriptions.

The range of motion for the compartment lids 154 can vary depending on whether a single lid or multiple coupled lids are being opened. For a single uncoupled compartment lid 154, the hinge 158 may allow the lid to pivot approximately 180 degrees from the closed position to the fully open position. When two or more compartment lids 154 are coupled together using the coupling system 168, the range of motion may be approximately 90 degrees to accommodate the linked configuration and prevent interference with adjacent compartments or drawer structures.

Referring to FIG. 4A, three dividers 148 are shown mounted in the drawer 104a and several of the removable dividing walls 138 are removed to reconfigure six compartments 142a into one large receptacle 144a. Each one of the dividers 148 is hingedly attached 150 on a single side to a respective one of the compartment lids 154 via hinges 158. That is, hinges 158a (see FIG. 7) can be attached to the compartment lids 154 and hinges 158b can be attached to the dividers 148, although alternatives are possible. The hinge rod 152 can extend into the associated channel and/or side wall of the drawer 104 between the hinges 158a, 158b to connect the compartment lids 154 to the dividers 148. The hinges 158 and hinge rod 152 allow the compartment lids 154 to pivot about pivot axis 160 between open and closed positions. The hinges 158 can be molded or forged integrally with the associated compartment lid 154 and/or dividers 148, although alternatives are possible.

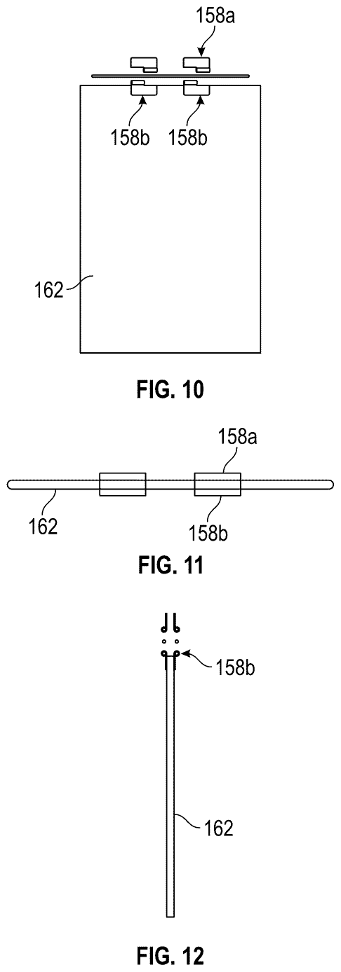

FIGS. 10-12 illustrate another divider 162 that is similar to divider 148 but has a double sided hinge 158. The divider 162 with the double sided hinge 158 is illustrated in FIG. 6 in sections 134a. The divider 162 is positioned along a center longitudinal axis X between a first column 164 of compartment lids 154 and a second column 166 of compartment lids 154. The double sided hinges 158 of the divider 162 allow for individual compartment lids 154 to respectively pivot about the longitudinal axis X between open and closed positions.

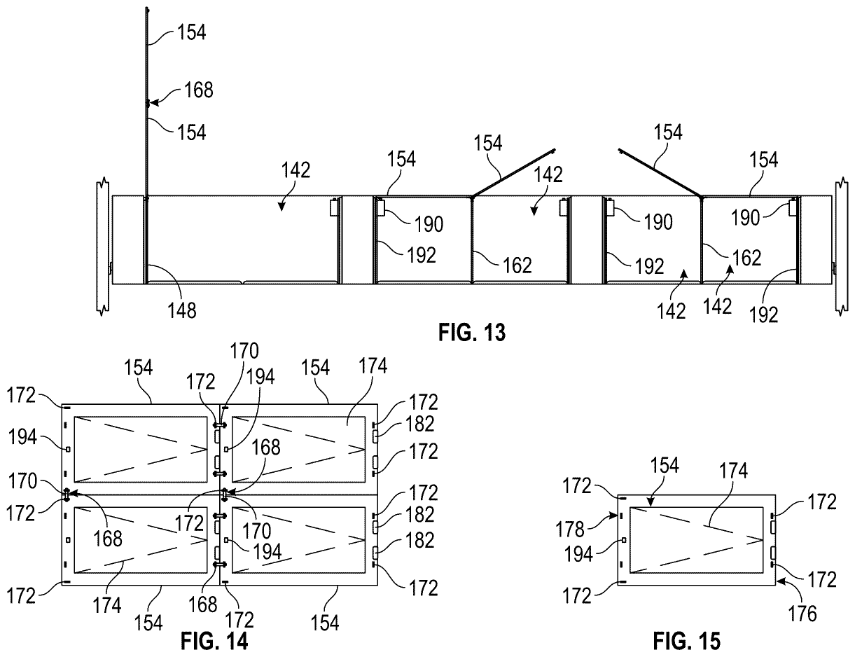

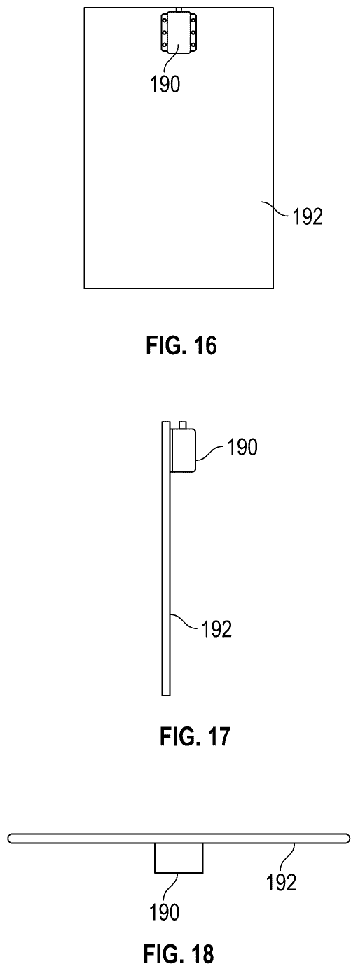

Referring to FIG. 13, the compartment lids 154 can open on the left or the right depending on how the dividers 148, 162 are positioned in the sections 134a of the drawer 104a. Reconfiguration can be done horizontally and/or vertically within a section of neighboring compartments 142 together. Reconfiguration creates a larger product space while keeping all adjacent product locations then same within the drawer. In certain examples, the max reconfiguration within a given section can be up to 12 inches in width and 21 inches in length, although alternatives are possible. As such, a user may couple a maximum of twelve single compartments 142 together per section in a drawer.

The vending machine may include drawer position sensors to detect the extension position of the drawers 104, 104a. These sensors can communicate with the controller to prevent actuation of the compartment lid solenoids 190 when a drawer is only partially extended from the enclosure 102. By preventing lid opening when the drawer 104, 104a is not fully extended, the system can reduce the risk of lid jamming, damage to the lids 154 or hinges 158, and mechanical failures. The position sensors may comprise optical sensors, magnetic sensors, mechanical limit switches, or other suitable detection mechanisms. In different embodiments they can be mounted on the lids 154, the hinges 158, or drawers 104 to accomplish each of the goals of detecting weight, object presence, malfunction or miscalibration of the drawer 104 or lid 154.

Turning again to FIG. 4A, two or more compartment lids 154 can be coupled together within the drawers 104, 104a to cover a larger compartment for increased product space. Two or more compartment lids 154 may be coupled together via a coupling system 168 (e.g., connectors) that includes a connecting rod 170 (e.g., pin) and a fixing part 172 (i.e., bracket, support structure), although alternatives attachments are possible.

Referring to FIGS. 14-15, multiple fixing parts 172 are shown on an inner side 174 of the compartment lid 154 at a first end 176 and a second end 178 thereof. In the example shown, there are a total of six fixing parts 172 on the compartment lid 154. The first and second ends 176, 178 are minor sides 185 of the compartment lids 154. The fixing parts 172 can have a rigid or semi-rigid construction with a U-shaped design that defines an opening 180 to receive an engaging rod such as the connecting rod 170. It will be appreciated that the shape of the fixing parts 172 may be any shape such as, but not limited to, circular, oval, or any other shape.

The fixing parts 172 are shown attached to the inner surfaces 174 of each one of the compartment lids 154. The first ends 176 of the compartment lids 154 define one or more cutouts 182 that are configured to receive hinges 158. The cutouts 182 can be positioned between two fixing parts 172 attached to the compartment lids 154 at the first ends 176 thereof. The openings 180 of the respective fixing parts 172 are configured to receive the connecting rod 170 for attaching or linking together one or more compartment lids 154 at the compartment lids 154 respective minor sides 185.

In one example, compartment lid 154a may have fixing parts 172a positioned at the second end 178 thereof that are adjacent to fixing parts 172b positioned at the first end 176 of compartment lid 154b. The fixing parts 172a, 172b can be positioned on the respective compartment lids 154a, 154b such that the openings 180 of the fixing parts 172a, 172b can be aligned to receive the connecting rod 170 therethrough. As such, the connecting rod 170 may be passed between the openings 180 of the respective fixing parts 172a, 172b to mount across the respective minor sides 185 of the compartment lids 154a, 154b to connect the compartment lids 154a, 154b together.

When the coupling system 168 is in place, the two compartment lids 154a, 154b in the section 134a of the drawer 104a can be connected together to pivot open in a left direction and to pivot closed in a right direction. The two compartment lids 154a, 154b can viewed in the section 134a of the drawer 104a as a single row where the two compartment lids 154a, 154b are horizontally positioned in the section 134a of the drawer 104a. The remaining four compartment lids 154c, 154d, 154e, 154f in the section 134a can also be aligned in respective rows that together form a first column 184 and a second column 186.

Still referring to FIGS. 14-15, the second end 178 of the compartment lids 154a, 154b may also include fixing parts 172c adjacent to corners of the respective compartment lids 154a, 154b. The fixing parts 172c can be positioned such that neighboring compartment lids 154c, 154d in the respective first and second columns 184, 186 of the section 134a of the drawer 104a can be connected to the compartment lids 154a, 154b along major sides 188 thereof. That is, the respective openings 180 of the fixing parts 172c located at the corners of the second ends 178 of the compartment lids 154a, 154b can be oriented and aligned with neighboring openings 180 of fixing parts 172c at the corners of the second ends 178 of adjacent compartment lids 154c, 154d, respectively. The connecting rods 170 can be inserted into the respective openings 180 of the fixing parts 172c on the compartment lids 154a, 154b, 154c, 154d to mount across respective major sides 188 thereof. As such, the connecting rods 170 can allow the compartment lids 154a, 154b, 154c, 154d to be connected or linked together along respective major sides 188. For example, as shown in FIG. 4A, connecting rod 170a is mounted across the major sides 188 of the compartment lids 154a, 154c and connecting rod 170b is mounted across the major sides 188 of the compartment lids 154b, 154d. Similarly, the coupling system 168 can be used to connect compartment lids 154c, 154e together along the major sides 188 and connect compartment lids 154d, 154f along the major sides 188.

Moreover, the coupling system 168 can connect compartment lids 154c, 154d together along the minor sides 185 and connect compartment lids 154e, 154f together along the minor sides 185. As such, one or more of the compartment lids 154a, 154b, 154c, 154d, 154e, 154f in a section 134a of the drawer 104a can be connected or linked together with the coupling system 168 to provide a larger lid cover for a larger receptacle 144a of the compartment 142a without having to replace the existing compartment lids 154 for a larger size.

It will be appreciated that any number of the compartment lids 154 can be linked or connected together per a given section 134 in the drawer 104. The flexibility of adding or removing the coupling system 168 allows various products varying in size to be reconfigured in a drawer with a lid. A user may revert the drawers to the original sized compartment by simply adding back in the dividers and uncoupling the compartment lids such that the lids cover the original sized compartment.

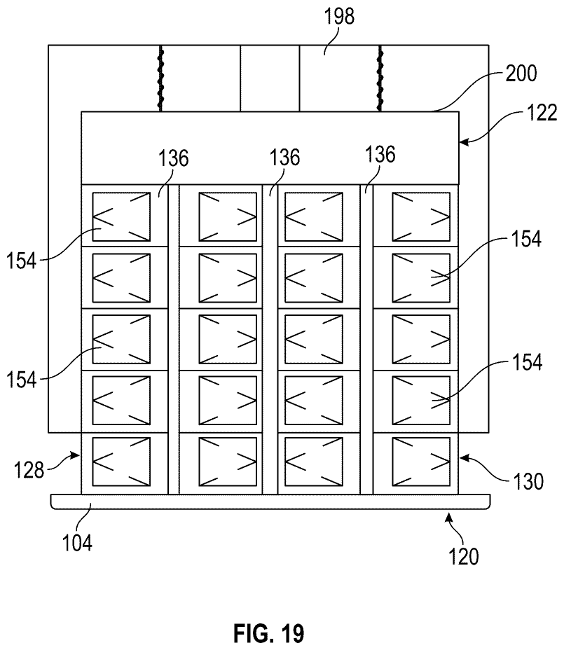

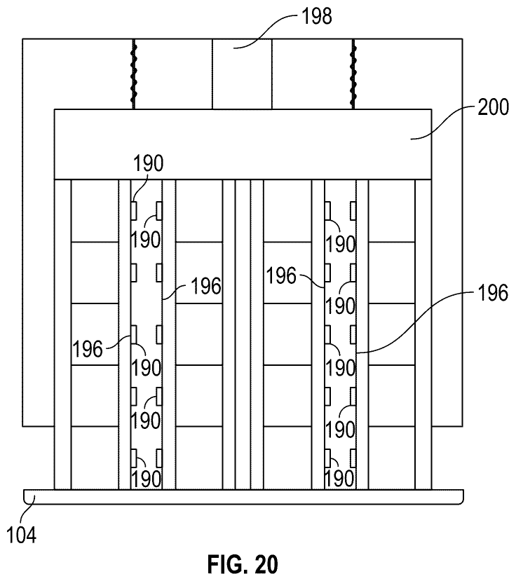

Turning again to FIG. 6, each individual compartment lid 154 can be locked/unlocked using a locking mechanism such as, but not limited to, a lock latching solenoid 190. The lock latching solenoid 190 may include a single solenoid capable of locking or unlocking all of the lids or may include multiple solenoids, each capable of locking or unlocking one or more of the lids. A lock divider 192 can be configured within any one of the drawers 104 to provide the latching solenoid 190 for reconfigured compartment lids 154. As depicted in FIG. 6 and FIG. 13, for example, the lock divider 192 can be mounted in the sections 134 of the drawer 104 as desired. The lock dividers 192 can be placed relative to the other dividers 148, 162 to provide a lock for the compartment lids 154. As such, even if one or more compartment lids 154 are connected together, a software program can trigger the lock solenoids 190 to unlock of each of the compartment lids 154 simultaneously to allow a user to then open the connected compartment lids together. That is, the software simultaneously triggers the lock solenoid(s) for the compartment lid(s) covering the selected product to allow user access to the product selected by the user. Each compartment lid 154 may include a latch member 194 (see FIG. 1A) configured to engage with the lock latching solenoid 190. Furthermore, each drawer 104 may be configured with a drawer solenoid 198 and wiring harness 200 to lock and unlock the drawers 104 as required. FIGS. 19-20 depict a top view of the drawer 104 shown in FIG. 1 with similar latching solenoids 190.

When multiple compartment lids 154 are coupled together using the coupling system 168, the controller can be configured to trigger the lock solenoids 190 for each coupled lid within milliseconds of each other. This synchronized unlocking allows the entire section of coupled lids to open together as a single unit, providing smooth operation and user experience. The millisecond-level timing coordination ensures that mechanical binding does not occur and that all lids in the coupled group are free to pivot simultaneously.

After a vending transaction is complete and the user has removed the selected product, the compartment lid 154 may close either automatically or manually. In certain embodiments, an automatic closing mechanism such as a hydraulic damper or spring mechanism can be integrated with the hinge 158 to automatically return the lid 154 to the closed position after opening. The automatic closing feature can improve security by ensuring lids are promptly secured after access. Alternatively, users may manually close the compartment lids 154 after product removal.

Similarly, the drawers 104, 104a may include automatic or manual closing mechanisms. After vending is complete, a drawer 104, 104a may close automatically via hydraulic, pneumatic, or spring mechanisms, or may be manually closed by the user pushing the drawer back into the enclosure 102.

Latching solenoids may require a certain amount of energy (e.g., a first energy burst) to open, and a similar amount of energy (e.g., a second energy burst) to close usually supplied by a large capacitor acting as a local energy reserve. A wiring harness 196 can be provided in the drawer 104 to provide such energy to the solenoids. The wiring harness 196 may also include in some embodiments, data lines, signal lines and other non-power supply functionality as well. It will be appreciated that the solenoid actuated lock mechanisms may be configured and/or mounted in different orientations. For example, the solenoid may be mounted on a compartment side of the lids or other operable locations on the compartment surfaces.

If a user has access to a product in a drawer then the drawer can be unlocked and withdrawn from an enclosure upon selection of the product or item to be dispensed. During use, a user may only withdraw a single drawer at a time. One or more solenoids engage the lids and/or the drawer in a deenergized state. Once a user inputs a code (e.g., biometrics, user identification, card, etc.) into a controller to indicate sufficient rights to gain access to a drawer, the solenoid energies to disengage from the drawer and/or the lids to allow access . If a user does not have access to a product selected in a drawer, the drawer will not be unlocked and cannot be withdrawn from the enclosure. If access is granted to the user and the drawer is withdrawn from the enclosure, only the compartment lid covering the compartment or location of the selected product will be unlocked. That is, all remaining compartment lids will remain locked to keep the other products within the drawer secure.

The cabinet assemblies 100, 100a can include integrated lighting systems to provide visual feedback to users and operators. Lighting elements such as LEDs can be positioned on each drawer 104, 104a and on or adjacent to each compartment 142, 142a within the drawers. The lighting serves multiple purposes further comprising signaling vending selections, indicating replenishment needs, and alerting operators to hardware issues or required maintenance. The lighting elements in some embodiments further comprise multiple lights, lights with various color spectrums and lights that strobe or pulse to draw attention. The lights may be integrated with optical sensor that performs optical detection of product size, shape, and color in a drawer 104, 104a or in a compartment 142,142a.

The cabinet assemblies 100, 100a in some embodiments further comprises communication hardware such as network interface cards, Wi-Fi modules, or cellular modems to enable remote connectivity. This connectivity allows the vending machines to conduct remote updates for software upgrades, quality checks, and troubleshooting. Authorized personnel can access the controller remotely to update firmware, modify operating parameters, review transaction logs, and diagnose issues without requiring physical access to the machine.

The software can interact with hardware components that are critical for device performance. The controller can generate error messages from sensors and solenoids when users leave drawers 104, 104a open or leave compartment lids 154 open beyond a predetermined time threshold. The diagnostic capabilities can identify where errors or failures occur within the device, such as identifying specific solenoids 190 that are malfunctioning or specific sensors that are providing erroneous readings. The system can also send reminders to operators for scheduled calibration of scale components or routine maintenance of mechanical components.

The cabinet assemblies 100, 100a in some embodiments, further comprises safety features to prevent tipping during operation. The controller is configured to allow only one drawer 104, 104a to open at a time during vending or replenishment operations. This software-enforced restriction prevents multiple heavy drawers from being extended simultaneously, which could cause instability. Additionally, anti-tip hardware components such as counterweights, floor anchors, leveling feet, or mechanical interlocks can be integrated with the enclosure 102. These anti-tip components in some embodiments are electromechanically coupled to the controller to provide real time response to dangerous loads or otherwise unsafe conditions for the cabinet.

The cabinet assemblies 100, 100a can support multiple compartment lid opening within a single drawer 104, 104a for item replenishment. During restocking operations, an authorized user can trigger the opening of multiple compartment lids 154 simultaneously or sequentially to efficiently replenish inventory across multiple compartments without requiring individual selections for each compartment.

The system in some embodiments further comprises intelligent product location management. If a compartment lid 154 does not open due to a stockout condition or hardware issue, the controller can identify the next available product location containing the same or equivalent product and automatically open the respective lid of that alternative location. This feature improves the user experience by ensuring product availability even when the primary location is depleted or experiencing technical difficulties.

The control architecture for the cabinet assemblies 100, 100a may employ different configurations depending on design requirements. In one embodiment, a single central controller board can be used to operate the entire device, with wiring harnesses extending from the central board to all drawers and compartments. In another embodiment, distributed control can be implemented with individual printed circuit boards (PCBs) for each drawer 104, 104a, wherein each drawer has its own dedicated control board. The distributed architecture may utilize small diameter cables that move in and out with the drawers to maintain electrical connections while allowing drawer movement. A central controller can communicate with the distributed drawer controllers via a communication bus or network to coordinate operations across the entire device. Other embodiments of the controller, further comprises the use and management of sensors performing optical detection of product size, shape, and color

Upon closure of an opened compartment lid by a user, the lock solenoid will re-lock the compartment lid on the drawer in which the user will be able to secure the drawer within the enclosure to be locked again. Once the drawer is locked in the enclosure, a user may be allowed to select another product to dispense. If the compartment lid or the drawer does not relock upon closure, an alert will be displayed on a user screen of the cabinet assembly 100. It will be appreciated that in other embodiments, drawers may be withdrawn or opened and closed automatically within an enclosure. Similarly, the compartment lids may be automatically closed once a user removes the selected product.

From the forgoing detailed description, it will be evident that modifications and variations can be made without departing from the spirit and scope of the disclosure.

What is claimed is

1. A cabinet assembly for a vending machine, comprising:
an enclosure defining an interior volume;
a plurality of drawers slidably movable with respect to the interior volume of the enclosure, the plurality of drawers each including one or more open-top compartments defined therein by at least one divider, the plurality of drawers being slidably movable between a closed position in which the one or more open-top compartments are enclosed within the interior volume and an open position in which the one or more open-top compartments are at least partially accessible;
a plurality of lids each hingedly attached to the drawer to respectively cover the one or more open-top compartments of an associated one of the plurality of drawers, each lid being configured to open to provide access to the corresponding one or more open-top compartments when the corresponding drawer is in the open position; and
one or more connectors coupling together one or more of the plurality of lids with an adjacent lid, wherein, when the at least one divider is removed from the drawer to reconfigure the one or more open-top compartments to a larger volume on the drawer, the one or more coupled lids cover the larger volume provided on the drawer.

2. The cabinet assembly of claim 1, wherein the one or more coupled lids are not removed or replaced to cover the larger volume on the drawer.

3. The cabinet assembly of claim 1, wherein the plurality of lids are translucent or clear.

4. The cabinet assembly of claim 1, further comprising a locking mechanism interconnected with at least one of the plurality of drawers and/or at least one of the plurality of lids to position the drawers or the lids in a locked or unlocked position.

5. The cabinet assembly of claim 4, wherein the locking mechanism includes a solenoid configured to engage and disengage the at least one of the plurality of drawers and/or the at least one of the plurality of lids.

6. The cabinet assembly of claim 1, wherein the plurality of drawers are accessible via an authentication process.

7. The cabinet assembly of claim 1, wherein the plurality of lids are accessible via an authentication process.

8. The cabinet assembly of claim 6, wherein the authentication process is associated with an employer identification.

9. The cabinet assembly of claim 7, wherein the authentication process is associated with an employer identification.

10. The cabinet assembly of claim 6, wherein the authentication process is associated with a key access card.

11. The cabinet assembly of claim 7, wherein the authentication process is associated with a key access card.

12. The cabinet assembly of claim 1, further comprising: a scale system integrated with an at least one of the plurality of drawers, the scale system further comprising: a platform positioned within the at least one drawer; an at least one load cell configured to detect force applied to the platform; and a junction hub operably connected to the at least one load cell and configured to convert a platform detected force to a weight measurement; and a controller operably connected to the scale system, the controller configured to: calibrate the scale system to a predetermined product weight; calculate a remaining inventory based on weight measurements from the scale system; and generate an alert when the remaining inventory reaches a predetermined threshold.

13. The cabinet assembly of claim 12, wherein the at least one load cell comprises a single point beam load cell or a platform load cell having a maximum weight capacity of 50 lbs.

14. The cabinet assembly of claim 12, wherein the scale system further comprises at least a vibration dampening pad positioned between the at least one load cell and the at least one drawer.

15. The cabinet assembly of claim 12, wherein the controller is configured to perform a periodic calibration of the scale system and send an electronic alert for recalibration.

16. The cabinet assembly of claim 12, wherein the scale system is configured to assign an at least one product SKU to each compartment for calibration accuracy.

17. The cabinet assembly of claim 1, wherein each of the plurality of lids includes a curved lip along an outer edge to reduce tampering, theft and/or potential damage.

18. The cabinet assembly of claim 1, further comprising a drawer position sensor configured to detect an extension position of at least one of the plurality of drawers, and wherein the locking mechanism is configured to prevent unlocking of the plurality of lids when the drawer position sensor indicates the drawer is not fully extended.

19. The cabinet assembly of claim 1, further comprising an automatic closing mechanism operably connected to at least one of the plurality of lids, the automatic closing mechanism comprising a hydraulic damper or a spring mechanism configured to return the at least one lid to a closed position after opening.

20. The cabinet assembly of claim 1, comprising a lighting system further comprising lighting elements positioned on each of the plurality of drawers and adjacent to each of the open-top compartments, the lighting system configured to visually signal vending selections, replenishment needs, or hardware issues using various signals, colors and pulsing frequencies.

21. The cabinet assembly of claim 1, further comprising a communication module configured to enable remote software updates, diagnostics, and troubleshooting.

22. The cabinet assembly of claim 1, wherein the enclosure includes anti-tip features comprising: rear drawer supports configured to stabilize the plurality of drawers when extended; and internal counterweights positioned to offset moments created by extended drawers.

23. The cabinet assembly of claim 1, wherein a controller is configured to allow only one of the plurality of drawers to open at a time to prevent tipping.

24. The cabinet assembly of claim 1, wherein a controller is configured to: detect when a compartment lid does not open due to a stockout or hardware issue; and automatically identify and open an alternative compartment lid containing an equivalent product.

25. The cabinet assembly of claim 1, wherein the locking mechanism comprises: a single central controller board configured to operate all drawers and lids; or a plurality of distributed printed circuit boards, each associated with a respective one of the plurality of drawers and connected to a central controller via a communication bus.

26. A method for assembling a modular vending drawer, the method comprising:
mounting a plurality of panels within the drawer, the panels being configured to fit between first and second ends of the drawer;
mounting a plurality of dividers between each frame, the dividers configured to fit within slots defined in the panels connecting together the plurality of dividers to define a plurality of open-top compartments, wherein the open-top compartment are reconfigurable to define larger spaces on the drawer;
mounting a plurality of lids over a respective one of the plurality of open-top compartments; and
connecting one or more of the plurality of lids together to cover larger spaces on the drawer when one or more open-top compartments are reconfigured.

27. The method of claim 26, further comprising interconnecting a locking mechanism with the modular vending drawer and/or at least one of the plurality of lids to position the drawer or the lids in a locked or unlocked position.

28. The method of claim 27, wherein the locking mechanism includes a solenoid configured to engage and disengage the modular vending drawer and/or the at least one of the plurality of lids.

29. The method of claim 26, wherein the modular vending drawer is accessible via an authentication process.

30. The method of claim 26, wherein the plurality of lids are accessible via an authentication process.

31. The method of claim 29, wherein the authentication process is associated with an employer identification.

32. The method of claim 30, wherein the authentication process is associated with an employer identification.

33. The method of claim 29, wherein the authentication process is associated with a key access card.

34. The method of claim 26, further comprising: integrating a scale system into the modular vending drawer, the scale system comprising a platform, at least one load cell, and a junction hub; calibrating the scale system to a predetermined product weight; and configuring a controller to calculate remaining inventory based on weight measurements from the scale system.

35. The method of claim 26, further comprising installing at least a lighting element on the modular vending drawer and adjacent to each of the plurality of open-top compartments.

36. The method of claim 27, further comprising installing a drawer position sensor configured to prevent the plurality of lids from unlocking when the drawer is not fully extended.

37. A retrofit kit for a vending drawer usable with a vending cabinet, the retrofit kit comprising:
a plurality of dividers attachable to the vending drawer to redefine a plurality of open-top compartments; and
a coupling system to link together an at least one existing compartment lids associated with a respective one of the redefined open-top compartments;
wherein the linked compartment lids are movable between an open position to provide access to the respective open-top compartments and a closed position to restrict access to the respective open-top compartments.

38. The retrofit kit of claim 37, further comprising: at least a scale component configured for integration into the vending drawer, the scale components comprising: at least a one load cell; a junction hub; and at least a vibration dampening pad.

39. The retrofit kit of claim 37, further comprising a lighting kit including at least a lighting element configured to be positioned adjacent to the open-top compartments.

40. The retrofit kit of claim 37, wherein the existing compartment lids further comprise at least a curved lip along outer edges to reduce tampering.
